(19) United States
(12) Patent Application Publication
(10) Pub. No.: US 2007/0086628 A1
(43) Pub. Date: Apr. 19, 2007

(54) System for automatically maintaining reference signatures

(76) Inventors: Frank Fuchs, Boblingen (DE); Klaus Wagemann, Leonberg (DE); Klaus Hausser, Steinenbronn (DE)

Correspondence Address: David I. Roche;BAKER & McKENZIE LLP, 130 E. Randolph Drive, Chicago, IL, 60601, US

(21) Appl. No.: 11/251,363

(22) Filed: Oct. 14, 2005

(51) Int. Cl. G06K 9/00

(52) U.S. Cl. 382/119

(57) ABSTRACT

A system to capture and to automate the maintenance of reference signatures for automatic signature verification systems. Generally, signatures as well as the identity of a person are captured from customer opening forms or recorded when subscribing for a service, which requires automatic signature verification. The identity (example customer name) and acquired signatures are stored into a database for later signature verifications required by business transactions. Rather than storing the initial reference signatures into the database, which is a manual time consuming process, signatures are taken from valid transactions and automatically stored into the database as a kind of reference signature. In paper based transactions the signature area of the document's image is taken and stored into the database as a so called “variant” to the reference customer or service identity. In paperless transactions the signature is taken directly from the input device and stored as a variant. This leads to a significant reduction in initial manual and continuous maintenance work needed. As individuals show variations in signatures over the years or they sign in two or several different forms (example: first name and last name or only last name), the signature reference database keeps the most up-to-date signature references without manual intervention.

### BACKGROUND AND SUMMARY OF THE INVENTION

The invention relates generally to the field of signature verification methods where a set of reference signatures can be automatically captured without manual intervention and where a set of reference signatures is automatically adapted to changing writing style or changed signature. On or more initial reference signatures are usually given by a real person when opening an account or enrolling for a service.

There has always been a need to verify a person's identity, particularly in the banking industry, retail industry, and securities industry and alike, where money transfer and payments is involved. In most systems currently in use, the person has to enroll himself or herself by providing a name, address, and other personal information, along with one or more valid signatures that will serve as reference signatures. In today's modern world the enrollment process for capturing all the required data can be automated in most respects, except for the initial signatures. This automatic process can also be done via telecommunication means (telephone, fax, e-mail etc.). As it is a cumbersome process to give a signature, capture it and store it into the database, there has been a long felt need for a procedure in which generally no reference signature has to be scanned or recorded during an enrollment process.

The signatures that people use often vary over time, sometimes changing dramatically. There has been a long felt need in the industry for a procedure to automatically update the reference signature without manual intervention and without acquiring a “new” reference or second or third sets of reference signatures.

In many of today's transaction systems where signatures are involved, such as banking systems, signatures will only be manually verified if the transaction exceeds a certain threshold amount. Because this kind of verification is a manual process, it is time and labor intensive. Banks and other users of signature verification are seeking ways to reduce such costs. In addition, because signatures change over time, most signatures are not up-to-date or may be missing. Thus, the manual signature verification may not allow reproducible and reliable results. But most fraudulent transactions happen below the threshold for verification. Therefore the industry is seeking for a means to automate the signature verification to enable signatures verification below the currently used amount threshold.

In order to do automatic signature verification it is essential to have good quality and up-to-date reference signature database. This is true for all signature verification engines. Therefore, a system is required that will assure that the most up-to-date reference signatures are stored. With such as system, the amount threshold may be lowered considerably and many currently undetected kinds of fraud, and the associated costs, could be avoided. In signature verification systems, each signature to be verified has a certain number of characteristics which can be evaluated by a system. The number of characteristics is called complexity. The higher the number of characteristics, the higher the complexity.

The banking industry generally distinguishes between two models in which customer, signatories, signatures and mandates are kept. There is a customer based model in which all signatories, signatures and mandates pertain to a customer, regardless of the number of accounts that belong to the customer. This means that a signature may be valid not only for one account but for several accounts of a customer, even though the signatures are stored physically only once. The second model is an account based model. In this model each account contains only those signatories, signatures and mandates, which pertain to a particular account, which means, that one signature can pertain only to one account. If another account needs the same signatory and signatures, such a signature must be captured in addition to the one stored in the different account.

Another distinction banks make is the handling of different types or categories of accounts, namely private account and corporate account. Private accounts usually have only one or two signatories which have unlimited signing rights, and this differs from a corporate account which has several or many signatories with different signing rights or authorizations.

For each of the account types, the preferred system should be configured to the actual needs of the bank. An initial account may have no signatory defined or may have 1-n signatories. If there are signatories defined, each signatory may have 0-m signatures stored. For each account the maximum numbers of variants are defined. (0-n signatories * max variants per signatory). A signature is called a variant, if the signature is stored as a reference that originates from a payment transaction rather than from account or service opening process.

Prior art systems include the one described in U.S. Pat. No 4,724,524, in which “current verification session” is held at which an existing set of reference signatures is replaced by a new set of reference signatures in order to adapt to new/changed writing styles. The process compares a signature set with another stored set of signatures references. Only similar signature sets will be further processed. With this means it is assured, that only new similar signatures will become new reference signatures of a reference set. In the system of U.S. Pat. No. 4,724,524 there must exists 2 sets of reference signatures, one set containing two original verified signatures and a second set containing four possibly correct signatures.

A customer who opens an account or enrolls for a service usually fills out a so called “enrollment form” either by himself or with the help of an account clerk. There are mandatory fields and optional fields for data input. One of the mandatory fields is one or sometimes (rarely) several boxes where the customer has to give his/her signature, with which he/she will sign when initiation a business transaction. The enrollment forms are scanned either directly at an office scanner or they are collected and sent to a central scanning service. After the scan process an operator has to go through each of the scanned signature images. If the scan service does not support area cropping the operator even has to crop the signature. The result in both cases is a signature snippet, which is then stored by the operator to the customer/account/signatory (called “binding” a signature to a signatory). A signature snippet area is an area of a paper document where a (several) signature(s) can be found. The process of removing of printed horizontal/vertical lines, removing of printed text and removing of certain dirt pixels in a scanned signature image.

In some of the financial institution, the enrollment form even contains printed text in the snippet area or even lines without using blind color (a single color printed text, lines, images on a paper document, which will not be captured by a scan process). These printed items, which do not belong to the signature, must be manually cleaned. Only such cleaned signature snippets can later be used by an automatic signature verification system.

As this is a time consuming and error prone process, financial institutions with such an approach usually have a bad signature reference database, which by no means can be used by an automatic signature verification system.

It is commonly known from experience that people change their signatures over time. Some of the financial institutions request new signatures from their clients from time to time (many years in between). However, this is seen by the institutions as an unfriendly interruption in the relation between institutions and customer. As a result, this process is rarely used at all. Only a handful of institutions continue this practice.

All financial institutions without exception cannot check all signatures, due to the high volume and the limited resource of skilled operators for signature verification. Therefore, only transactions above a certain currency amount limit will be checked.

There are many deficiencies in today's signature reference databases, very often signatures are missing at all, signatures are of low quality or signatures are simply too old. Human operators who check a transaction above a certain limit take quite some time to find out whether the signature is correct or not, they sometimes even call the customer to verify the transaction.

One of several advantages of the present invention is that it is known (as of today known by the authors) as the only means to build up a signature reference database automatically with transaction data, which can later be used by an automatic signature verification system.

Another advantage is, as this invention enables automatic system verification, the amount checking limit can considerably decreased or even set to zero. As the most fraud happens below the today's limits a high number of losses are avoided.

As the invention assures that a signature database holds always the latest signatures, signature verification costs can be considerably decreased regardless whether automatic or manual signature verification is used, but the benefit when using automatic signature verification is factors higher than by manual verification.

The present invention contains only one set of reference signatures, and adapts to new signatures of a customer one signature at a time. The present invention stores only non-similar signatures, whereas prior art systems store only similar signatures. Generally speaking, the present invention stores only such types of signatures as reference signatures that do not have any similarities with one of the existing reference signatures.

The present invention is a system for building up a reference signature database without manual intervention that can be used by a signature verification engine (a system which can compare signatures).

### BRIEF DESCRIPTION OF THE DRAWINGS

FIG. 1 is a flowchart of a method of maintaining a set of reference signatures; steps are marked with numbers 1-8 in parentheses.

FIG. 2 is a diagram showing alternative algorithms useable with the present invention.

### DETAILED DESCRIPTION OF PREFERRED EMBODIMENTS

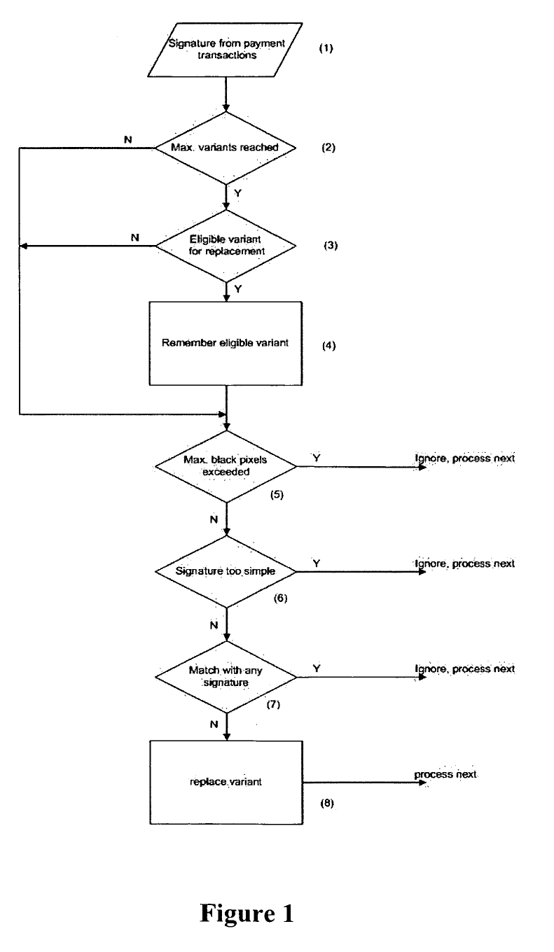

In step (1) of FIG. 1, a signature of a payment transaction is taken, either already available as a signature snippet or cropped out of the transaction form and cleaned. Cleaning means that printed horizontal or vertical lines and some of the dirt in the signature snippet area is automatically removed such a cleaned snippet is taken as input. This can be done, for example, using standard image clean-up software, such as SIVAL.

As each transaction belongs to an already enrolled person (a non enrolled person cannot initiate a transaction) the person and with it his/her account can be clearly identified. The account holds, as described previously 0-n signatories. It also holds the defined max number of variants for the account. This is shown as step (2) in FIG. 1. If the max number of variants is not reached, we go to element (5). Otherwise we go to step (3) of FIG. 1.

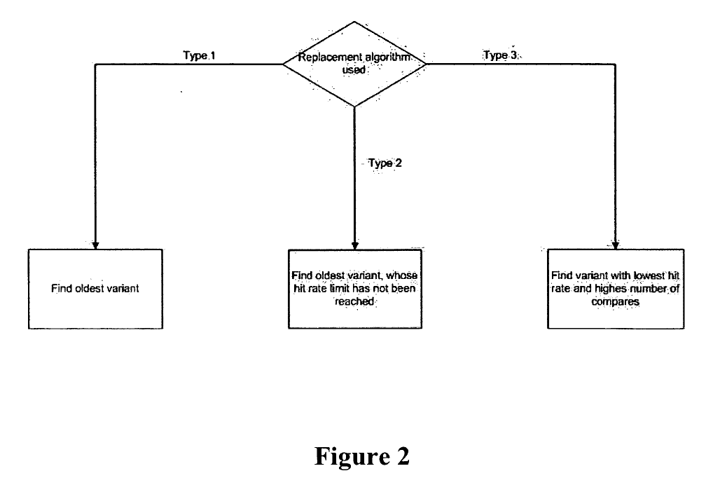

Step (3) of FIG. 1 is described in more detail in FIG. 2. The result of this step is a true/false output, whether a variant could be found, which is eligible for a replacement with the new signature. Step (4) of FIG. 1 shows that if a variant was found eligible for replacement, it is remembered for possible later deletion in step (8) of FIG. 1.

At step (5), the signature snippet will be analyzed to determine whether it contains too much dirt. Dirty signature snippets cannot be used in automatic signature verification. The so called dirt limit is defined in percentage of black pixels of the whole number of pixels in the signature snippet. If the percentage is exceeded the snippet will not be used as a variant and is ignored.

Step (6) determines whether the signature snippet is too simple; if there is too few pixels and/or low complexity (too simple), it will not be used as a variant. Low complexity of a signature can be determined by standard signature software such as SIVAL.

In step (7), the signature of the snippet is automatically compared with each of the signatures/variants of the account. If the snippet matches with one of the stored signatures/variants, the signature snippet will not be used as a variant, since the account contains already a very similar signature/variant.

If a variant was already marked as being eligible for deletion in step (4), the marked variant will be deleted in step (8), and will be replaced with the current signature snippet. If none was marked eligible for deletion, the current signature snippet will be added as a new variant.

The variant will be marked as non usable for a settable number of days, typically 60 or 90 days. This is necessary for in order to avoid the activation of fraudulent new signatures, which are stored as reference signatures. Reference signatures will be activated only after a certain time frame during which a customer can void an invalid transaction (fraudulent transaction). Signatures identified by void transactions will be taken out of the reference database or will be marked as a fraudulent signature. They will never be activated or used by an automatic signature verification system.

Today's banking industry is analyzing each payment above a certain currency amount for fraud. Various different systems are used, apart from signature verification, to detect fraud.

Signatures from such fraudulent transactions, which were or should be stored as variants will be either not stored into the system or marked as fraudulent or deleted from the database, depending upon whether the fraud was identified before or after signature verification took place and whether fraudulent signatures should be kept for later reference or audit purposes.

The term “signature compare” or “compare” refers to the process of comparing two signatures. The result of a signature compare is a match rate.

A signature compare engine is a system that compares one or more signatures and returns for each compare the resulting match rate. The level (percentage) at which two signatures are similar is called the match rate. The term “signature match” is typically use to refer to a situation where two signatures have a certain level of similarity, for examples 80%.

When comparing two signatures, if they compare at a specified level (example 85%), then there is what may be called a “hit”. The term “hit rate” refers to the ratio defined by the number of hits to the total number of compares.

FIG. 2 is a more detailed description of step (3) of FIG. 1. The system described herein may utilize at least three different variant replacement algorithms, and perhaps others. A Type 1 algorithm is simply that the oldest variant will be selected. For a Type 2 algorithm it is essential, that an automatic signature verification system is put in place, which records for each variant of a signatory/account/customer the number of hits (when comparing signatures) in the database. If such a system is in place, the algorithm is an improvement over type 1. With the Type 2 algorithm, a system wide threshold number is being defined which specifies the number of hits for each variant. The algorithm selects the oldest variant with a hit number lower than the system wide threshold for replacement. Each variant in the whole system has a unique time stamp. A time stamp is a system wide time unique token, usually derived from a database system. No two equal time stamps can occur in one system.

As with the Type 2 algorithm, it is essential for using the Type 3 algorithm an automatic signature verification system is put in place which records the same values as for Type 2. However, in addition, for the Type 3 algorithm each variant must also contain the number of compares regardless whether there was a hit or not. If such a system is in place, the algorithm is an improvement over the Type 2 algorithm. The variant is selected for replacement, which holds the lowest ratio hits/compares (hit rate) and the threshold “minimum number of compares” has been reached. This number is a system wide defined threshold.

The preferred form of the invention should be a program, which is fed by all the data of a financial transaction including the signature. In paper based transactions the whole front and back image and if possible the signature snippets area should be part of the input.

The program stores signatures as references, but they are by no means initial references. Rather, the stored signatures are called variants. As the system filters signatures to the reference database it is called further “Signature Reference Filter” or “SRF”. Variants among the reference signatures in a reference database can be used to bridge gaps during the long recording phase when introducing automatic signature verification in payment transactions.

With a set of properties, the manner of the storing of variants to a customer/account can be controlled. With different sets of properties, the algorithm can be adjusted to take into consideration: the real-life needs for all the various customer/account types, the actual data that is available, the needs of a banking target application and the needs of the variations in banking environments.

Properties which can be set to on/off:
If there is only one signatory for the current customer AND this signatory has no signature yet, then a signature is created instead of a variant;
The oldest variant will be deleted, if the maximum number of variants for a customer is reached, before adding the new variant;
The customer will be created for the current variant, if this customer does not exist;
If the account does not exist, an account will be created for the current variant;
The maximum number of variants for a customer: This is an average value dependent on the number of signatories of a customer. If this number is for example 3 and a customer/account has 4 signatories, then this limit is reached, when there are 12 variants in the customer/account, regardless to whom the variant is assigned to;
The maximum number of variants for a private customer;
The maximum number of variants for a corporate customer;
The maximum number of variants for neither private nor corporate customers;
If the current customer has only one signatory, the variant will be automatically assigned to this signatory;
Every variant will be assigned to the oldest signatory of this customer.

The task of the SRF is to filter the data with the same signatures, to prevent the loading of any images that are similar to the reference signatures or variants. “Similar” in this sense is used to mean that the result match rate of two signatures is higher than the configured setting of a system wide defined match rate. The signature comparison is done by a signature compare engine (such as SIVAL).

The SRF can handle both the account and customer model. Depending on the model the appropriate signatures and variants will be retrieved from the database. A maximum of three signatures can be processed in one step as input to the system. In paper based systems this is the first and the second signature on the front page and the third signature on the back page of check or document, in paperless transactions it is usually one signature originally recorded on a signature input device, such as pad etc. These signatures in conjunction with other transaction are usually coming as an input stream or as an input file as input data for a signature verification system.

All signatures from an input stream/file will be loaded per customer/account to a vector. Additionally, the signatures from the signature reference database for this customer/account will be loaded to this vector. All signatures in a vector will be compared to each other.

All signatures of a customer/account will be written in one vector and the match rates will be evaluated. For every signature a value “max nodes” will be created, that shows how often the signature with others signatures matches.

The other value is a max match rate sum per signature (match rate between the current signature and other signatures). The signature with a max match rate sum or max nodes will be selected as the first one for further evaluation. In this case the value “1” will be set for the accepted signature. Then, the accepted signature will be compared with the other signatures to determine similarity.

### EXAMPLE:

We compare four signatures in the chart below. The signature 0 is selected as the first one. This signature will be compared with the signatures 1, 2 and 3. Where the selected signature matches (that means that the signatures are similar) a value “1” will be set into the table. The signature 0 matches with the signature 1 (79%), with signature 2 (100%) and with the signature 3 (88%), so the signature 2 and 3 will be not selected (they are similar with signature 0). Signature 1 is dissimilar with signature 0 (assuming a match threshold or match rate limit of 80%).

In the table below, only the signature 0 and 1 are selected for “indirect similarity” check because they don't match. For these two signatures, whose resulting match rate is smaller than match rate limit the match rate of the indirect similarity will be evaluated.

| Signature No. | 0 | 1 | 2 | 3 | n | Max mr |
|---|---|---|---|---|---|---|
| 0 | X | 79 | 100 | 88 | 2 | 267 |
| 1 | 79 | X | 83 | 21 | 1 | 183 |
| 2 | 100 | 83 | X | 0 | 2 | 183 |
| 3 | 88 | 21 | 0 | X | 1 | 109 |

n = number designating how often the signature matches with another one in the row
mr = match rate
result:
select variant 0, n = 2, Max mr = 267

The meaning of the match rate of the indirect similarity is that non-matched signatures could get similarity through other signatures. So, for example, the signature 0 doesn't match with the signature 1, because it has a match rate of 79% (79% is lower than the 80% score required to have a match), but we know that the signature matches with the signature 2 with a match rate of 83%, and the signature 2 matches with the signature 0 with a match rate of 100%. Taking this into account we see that signatures 1 and 2 belong to the same person, like the signatures 2 and 0.

The term “match” as used herein refers to a similarity that meets settable criteria. For example, with electronic signature data (i.e., paperless signature data) the criteria to establish a match may be set quite high, perhaps greater than 90%. On the other hand, with paper-based images of signatures, where background noise may be present, a match may be determined based on a lower percentage, perhaps as low as 80%, for example.

The term “signature information” as used herein refers to an image of a signature in a paper-based transaction or, in the alternative, signature data from an input device in the context of a paperless transaction. Both paper-based and paperless transactions are suitable for making use of the system of the present invention.

The the term “invention” has sometimes been used herein to refer to what in effect are a plurality of inventions, as indicated by the inclusion below of serveral claims. Use of the singular form of the word should not be understood as a limiting the claims to a particular combination of limitations. The inventions described and claimed herein have sometimes been described in considerable detail with reference to certain preferred embodiments or features. However, a person of ordinary skilled in the art will appreciate that the inventions described and claimed herein can be practiced by other than the preferred embodiments, which have been presented for purposes of illustration and not of limitation. Therefore, the spirit and scope of the appended claims should not be limited to the description of the preferred embodiments contained herein.

We claim:

1. A method for maintaining a set of reference signatures for use in a signature verification system comprising:
establishing reference signature data containing information corresponding to one or more reference signatures,
capturing a first new set of signature information,
associating that new set of signature information with an account,
evaluating the first new set of signature information to determine whether it is suitable for comparison to the reference signature data, and
if the new set of signature information is suitable for comparison to the reference signature data, determining whether the new set of signature information constitutes a match with one or more signatures included within the reference signature data, and
if the new signature information does not constitute a match with signatures in the reference signature data, adding the new set of signature information to the reference signature data, and if necessary, replacing information corresponding to one or more reference signatures that matched with the new set of signature information.

2. A method in accordance with claim 1 wherein
replacing information corresponding to one or more reference signatures that matched with the new set of signature information is done with a step selected from the group consisting of: a) replacing the data corresponding to the oldest variant within the reference signature data, b) replacing the data corresponding to the oldest variant within the reference signature data whose hit rate is lowest, and c) replacing the data corresponding to the oldest variant within the reference signature data having the highest number of compares and the lowest number of hits.

3. A method in accordance with claim 2 wherein
establishing reference signature data containing information corresponding to one or more reference signatures is done without a separate enrollment process by saving acquired signature data from a transaction as it occurs and waiting a pre-determined period of time for fraud claims to be made before using the acquired set of signature data.

4. A method in accordance with claim 3 wherein
the reference signature data is designed to correspond to multiple signatories, corresponding to one or more accounts.

5. A method in accordance with claim 4 wherein
the signature data is dynamic electronic signature data obtained from an input device.

6. A method in accordance with claim 4 wherein
the signature data is static electronic signature data obtained from paper-based signature.

7. A method in accordance with claim 6 wherein
evaluating the first new set of signature information to determine whether it is suitable for comparison to the reference signature data includes checking whether the signature data exceeds a maximum allowed number of black pixels.

8. A method in accordance with claim 6 wherein
evaluating the first new set of signature information to determine whether it is suitable for comparison to the reference signature data includes checking whether the signature data is sufficiently complex to qualify for comparison.

9. A method in accordance with claim 6 wherein
determining whether the new set of signature information constitutes a match with one or more signatures included within the reference signature data comprises consideration of both direct and indirect matches.

10. A method for maintaining a set of reference signatures for use in a signature verification system comprising:
establishing reference signature data containing information corresponding to one or more reference signatures,
capturing a first new set of signature information,
associating that new set of signature information with an account,
determining whether the new set of signature information constitutes a match with one or more signatures included within the reference signature data, and
if the new signature information does not constitute a match with signatures in the reference signature data, adding the new set of signature information to the reference signature data, and if necessary, replacing information corresponding to one or more reference signatures that matched with the new set of signature information.

11. A method in accordance with claim 10 wherein
replacing information corresponding to one or more reference signatures that matched with the new set of signature information is done with a step selected from the group consisting of: a) replacing the data corresponding to the oldest variant within the reference signature data, b) replacing the data corresponding to the oldest variant within the reference signature data whose hit rate is lowest, and c) replacing the data corresponding to the oldest variant within the reference signature data having the highest number of compares and the lowest number of hits.

12. A method in accordance with claim 11 wherein
establishing reference signature data containing information corresponding to one or more reference signatures is done without a separate enrollment process by saving acquired signature data from a transaction as it occurs and waiting a pre-determined period of time for fraud claims to be made before using the acquired set of signature data.

13. A method in accordance with claim 12 wherein
the reference signature data is designed to correspond to multiple signatories, corresponding to one or more accounts.

14. A method in accordance with claim 13 wherein
the signature data is dynamic electronic signature data obtained from an input device.

15. A method in accordance with claim 13 wherein
the signature data is static electronic signature data obtained from paper-based signature.

16. A method in accordance with claim 10 wherein the method further comprises:
evaluating the first new set of signature information to determine whether it is suitable for comparison to the reference signature data by checking whether the signature data exceeds a maximum allowed number of black pixels.

17. A method in accordance with claim 10 wherein the method further comprises:
evaluating the first new set of signature information to determine whether it is suitable for comparison to the reference signature data by checking whether the signature data is sufficiently complex to qualify for comparison.

18. A method in accordance with claim 10 wherein
determining whether the new set of signature information constitutes a match with one or more signatures included within the reference signature data comprises consideration of both direct and indirect matches.

19. A method for maintaining a set of reference signatures for use in a signature verification system comprising:
establishing reference signature data containing information corresponding to one or more reference signatures,
capturing a first new set of signature information,
associating that new set of signature information with an account,
determining whether the new set of signature information constitutes a match with one or more signatures included within the reference signature data, and
if the new signature information does not constitute a match with signatures in the reference signature data, adding the new set of signature information to the reference signature data, and if necessary, replacing information corresponding to one or more reference signatures that matched with the new set of signature information, wherein replacing information corresponding to one or more reference signatures that matched with the new set of signature information is done with a step selected from the group consisting of: a) replacing the data corresponding to the oldest variant within the reference signature data, b) replacing the data corresponding to the oldest variant within the reference signature data whose hit rate is lowest, and c) replacing the data corresponding to the oldest variant within the reference signature data having the highest number of compares and the lowest number of hits.
